(19) United States
(12) Patent Application Publication
(10) Pub. No.: US 2007/0298863 A1
(43) Pub. Date: Dec. 27, 2007

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/582,410

(22) Filed: Oct. 18, 2006

Related U.S. Application Data
(60) Provisional application No. 60/811,411, filed on Jun. 7, 2006.

(51) Int. Cl. A63F 13/00

(52) U.S. Cl. 463/20

(57) ABSTRACT

When a bonus game is won in a unit game while a base game is being executed, a stop control game in which reels are stopped by push of stop switches is executed. The bonus game is executed when a player pushes the stop switches to stop the reels in the stop control game, and a symbol combination serving as a bonus game trigger is stopped on a payline. When the symbol combination serving as the bonus game trigger is not stopped on the payline, the stop control game is executed plural times without consuming credits. When the symbol combination serving as the bonus game trigger is not stopped on the payline even if the stop control game is executed a predetermined number of times, the symbol combination serving as the bonus game trigger is automatically stopped on the payline by a control of a main CPU.

### CROSS REFERENCE TO RELATED APPLICATION

This application claims priority to co-pending U.S. provisional patent application Ser. No. 60/811,411 entitled “SLOT MACHINE AND PLAYING METHOD THEREOF” filed on Jun. 7, 2006 and naming Kazuo OKADA as inventor, and which is incorporated by reference herein for all purposes.

### BACKGROUND OF THE INVENTION

1. Field of the Invention

The present invention relates to a slot machine which allows a player to play a game by using a game medium such as a coin and a bill, and to a playing method thereof.

2. Description of the Related Art

Conventional slot machines are disclosed in U.S. Pat. No. 6,960,133 B1 and U.S. Pat. No. 6,012,983. In each of the conventional slot machines, when a player inserts a game medium such as a medal, a coin, and a bill into an insertion slot of the slot machine and pushes a spin button, a plurality of symbols are scrolled on a display unit provided on a front surface of a cabinet. After a little while, the plurality of symbols are automatically stopped. When the scroll of the respective symbols is started at the moment when the spin button is pushed, lottery of random numbers is performed. When the player wins a shift to a bonus game such as a mystery bonus or a second game by the lottery of random numbers, the slot machine shifts a gaming mode from a base game to the bonus game, and allows the player to play the bonus game. Then, the slot machine executes a payout for the player depending on a winning state which occurs in response to a progress of the game.

In the conventional slot machines, the scrolled symbols are only stopped automatically. Accordingly, appearance of a slot machine provided with a new entertainment factor is desired.

### SUMMARY OF THE INVENTION

It is a first aspect of the present invention to provide a slot machine including: a display; and a controller configured to shift a game mode to a stop control game based on an external control input signal only when a combination of a plurality of symbols arranged on the display coincides with a specific combination, in a case of rearranging the plurality of symbols on the display, the stop control game making it possible to rearrange the plurality of symbols.

In the slot machine according to the first aspect of the present invention, only when the combination of the symbols coincides with the specific combination, the controller shifts the game mode to the stop control game, and rearranges the symbols based on the external input signal.

It is a second aspect of the present invention to provide a slot machine including: a display; and a controller configured to be capable of rearranging a plurality of symbols arranged on the display, and decide a combination of the symbols to be rearranged. When the combination of the symbols coincides with a specific combination, the controller shifts a game mode from a base game in which the plurality of symbols are automatically rearranged to a stop control game, the stop control game making it possible to rearrange the plurality of symbols for a predetermined period based on an external control input signal.

In the slot machine according to the second aspect of the present invention, when the combination of the symbols coincides with the specific combination, the controller shifts the game mode from the base game to the stop control game. In the stop control game, the controller rearranges the symbols based on the external control input signal. Moreover, the stop control game is executed for the predetermined period.

It is a third aspect of the present invention to provide a slot machine including: a display configured to include a symbol matrix composed of a plurality of columns and a plurality of rows, and a payline set on the symbol matrix; an arrangement controller configured to decide symbols to be arranged on the symbol matrix after scrolling a plurality of the symbols on the display, and stop scrolling the plurality of symbols to arrange the decided symbols on the symbol matrix; a stop switch connected to the arrangement controller and configured to be operatable by a player; and a stop switch controller configured to activate an operation for the stop switch only when a combination of the symbols arranged on the payline coincides with a specific combination, and rearrange the symbols on the symbol matrix in response to operation input timing for the stop switch by the player.

In the slot machine according to the third aspect of the present invention, the stop switch operatable by the player is provided. When the combination of the symbols arranged on the payline coincides with the specific combination, the operation for the stop switch is activated. Moreover, the stop switch controller rearranges the symbols in response to the operation timing for the stop switch.

It is a fourth aspect of the present invention to provide a playing method of a slot machine including: repeating a unit game in which a plurality of symbols are automatically rearranged so that a combination of the symbols can be arranged on a display, the combination being decided by a controller; and making it possible to rearrange the plurality of symbols based on an external arrangement signal only when the combination of the symbols coincides with a specific combination.

In the playing method of a slot machine according to the fourth aspect of the present invention, when the combination of the symbols, which is decided by the controller, coincides with the specific combination, the symbols are rearranged based on the external arrangement signal.

It is a fifth aspect of the present invention to provide a playing method executed in a slot machine including: deciding a plurality of symbols by a controller, the symbols to be rearranged on a display, in a case of rearranging the plurality of symbols arranged on the display; rearranging, on the display, the plurality of symbols decided by the controller; and activating an operation for a stop switch connected to the controller only when a combination of the symbols rearranged on the display coincides with a specific combination, and executing the rearrangement of the plurality of symbols in response to the operation for the stop switch.

In the playing method executed in a slot machine according to the fifth aspect of the present invention, the symbols to be rearranged are decided by the controller. When the combination of the decided symbols coincides with the specific combination of the symbols, the operation for the stop switch is activated, and the symbols are rearranged in response to the operation for the stop switch.

It is a sixth aspect of the present invention to provide a playing method executed in a slot machine including: repeating a unit game in which a game is started by scrolling a plurality of symbols on a display based on a control of a controller, and the game is ended by arranging the plurality of symbols on the display based on a control of the controller; executing, as a first control state, rearrangement of the plurality of symbols based on an arrangement signal from a stop switch connected to the controller when a combination of the symbols arranged on the display coincides with a specific combination; determining whether or not the combination of the rearranged symbols coincides with the specific combination in the first control state; and automatically rearranging the plurality of symbols as a second control state to realize a combination of symbols decided by the controller when the combination of the rearranged symbols coincides with the specific combination.

In the playing method executed in a slot machine according to the sixth aspect of the present invention, when the combination of the arranged symbols coincides with the specific combination, the stop switch is activated by the controller, and the rearrangement of the symbols is performed as the first control state based on the arrangement signal from the stop switch. Moreover, when the combination of the symbols coincides with the specific combination in the first control state, the rearrangement of the symbols is automatically performed as the second control state.

Note that the above-described stop switch may be a mechanical button switch, or may be a switch such as a touch panel. As long as the switch is operatable by the player from the outside, and brings an occasion to generate the input signal, such a switch can be employed as appropriate.

### BRIEF DESCRIPTION OF THE DRAWINGS

FIG. 1 is a flowchart showing a playing method of a slot machine according to an embodiment of the present invention.

FIG. 2 is a perspective view showing the slot machine according to the embodiment of the present invention.

FIG. 3 is an explanatory view showing symbols displayed on three reels mounted on the slot machine and code numbers assigned to the symbols according to the embodiment of the present invention.

FIG. 4 is a block diagram of a control circuit of the slot machine according to the embodiment of the present invention.

FIG. 5 is a flowchart showing a process procedure of authentication reading of a game program and a game system program by a mother board and gaming board of the slot machine according to the embodiment of the present invention.

FIG. 6 is a flowchart showing a process procedure of a base game executed by the slot machine according to the embodiment of the present invention.

FIG. 7 is a flowchart showing a process procedure of a stop control game executed by the slot machine according to the embodiment of the present invention.

FIG. 8 is a flowchart showing a procedure of a lottery process executed by the slot machine according to the embodiment of the present invention.

FIG. 9 is an explanatory view showing plural types of winning combinations, establishment probabilities of the respective winning combinations, and the number of payouts for the respective winning combinations in the slot machine according to the embodiment of the present invention.

FIG. 10 is a flowchart showing a process procedure of a reel rotation control executed by the slot machine according to the embodiment of the present invention.

FIGS. 11A, 11B, 11C and 11D are explanatory views schematically showing rotation actions of the reel of the slot machine according to the embodiment of the present invention.

FIG. 12 is an explanatory view showing correspondences between the numbers of steps and the code numbers in the slot machine according to the embodiment of the present invention.

FIG. 13 is a flowchart showing a process procedure of a bonus game executed by the slot machine according to the embodiment of the present invention.

FIG. 14 is an explanatory view showing a display example of notifying a player of that the player can play the stop control game in the slot machine according to the embodiment of the present invention.

### DETAILED DESCRIPTION OF THE INVENTION

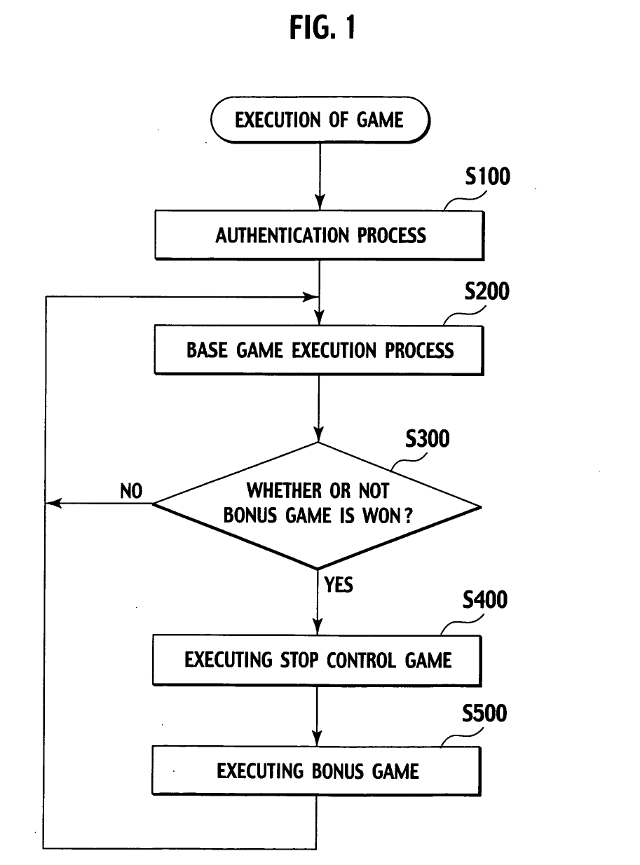

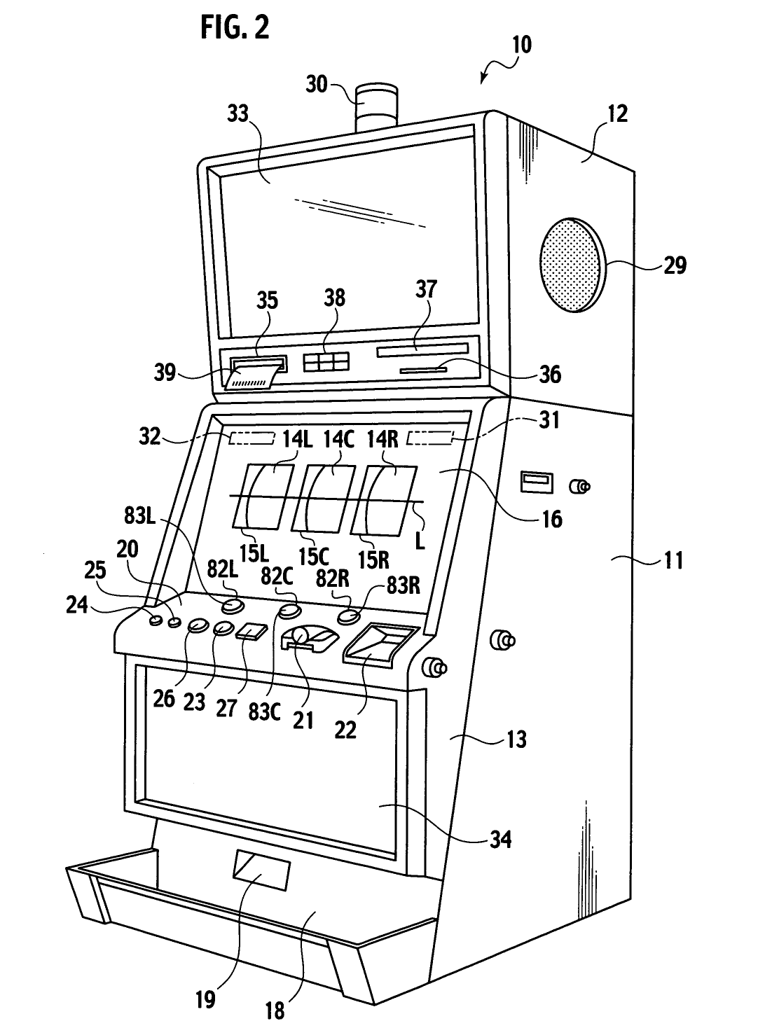

A description will be made of schematic actions in a slot machine and a playing method thereof according to an embodiment of the present invention with reference to FIGS. 1 and 2.

Upon being activated by receiving a supply of power, a slot machine 10 performs an authentication process (Step S100). In the authentication process, the slot machine 10 performs an initial verification process at a previous stage before starting a unit game, for example, a process for determining whether or not a program for operating a system is normally operated, and a process for determining whether or not the program is not tampered with.

Next, the slot machine 10 executes a base game (Step S200). In the base game, a player inserts one or more coins into a coin receiving slot 21, bets a desired number of credits on the current unit game, and pushes a spin button 23. Then, the slot machine 10 starts rotations of reels 14L, 14C and 14R, and after a little while, stops the rotations of the reels 14L, 14C and 14R. In each unit game, the slot machine 10 performs lottery to decide whether or not a bonus game is won.

Next, based on a result of the above-described lottery, the slot machine 10 determines whether or not the bonus game is won (Step S300). If the bonus game is not won (NO in Step S300), the slot machine 10 shifts the current unit game to the next unit game. Note that, when a combination of stopped symbols coincides with a winning combination, the slot machine 10 executes a payout for the player, and shifts the current unit game to the next unit game.

If the bonus game is won (YES in Step S300), the slot machine 10 executes a stop control game (Step S400). The stop control game is a game to stop the rotating reels 14L, 14C and 14R in response to operations for stop switches 82L, 82C and 82R by the player.

In the stop control game, in response to the stopping operations for the stop switches 82L, 82C and 82R, the player can stop the reels 14L, 14C and 14R, and can present a symbol combination (for example, a symbol combination of “APPLE”) serving as a bonus game trigger on display positions of display windows 15L, 15C and 15R. Specifically, in the case where a payline L (refer to FIG. 2) is set on the display positions of the display windows 15L, 15C and 15R, when the symbol combination of “APPLE” is stopped on the payline L, the bonus game trigger is generated.

The case is considered, when the player pushes the stop switches 82L, 82C and 82R, where the respective symbols of “APPLE” provided on the rotating reels 14L, 14C and 14R are present on the payline L of the respective display windows 15L, 15C and 15R, or where the respective symbols of “APPLE” are present at neighboring positions to the display windows 15L, 15C and 15R. In such a case, the slot machine 10 stops the symbols of “APPLE” on the payline L. Note that, when the symbols of “APPLE” are not present at the above-described positions, the slot machine 10 does not stop the symbols of “APPLE” on the payline L.

As described above, the slot machine 10 executes the stop control game, and then stops the rotating reels 14L, 14c and 14R in response to the stopping operations for the stop switches 82L, 82C and 82R by the player in the respective unit games. Then, in the case where the symbol combination of “APPLE” is stopped on the payline L when the reels 14L, 14C and 14R are stopped, the slot machine 10 shifts the current unit game from the stop control game to the bonus game (Step S500).

Note that, in the case where the symbol combination of “APPLE” is not stopped on the payline L, when a 1-BET button 26 or a maximum-BET button 27 is pushed, the slot machine 10 starts the rotations of the reels 14L, 14C and 14R, and executes the stop control game one more time. In this case, the credits are not consumed, and accordingly, the player can play the current unit game without reducing the coins or the number of credits. Moreover, in the case where the symbol combination of “APPLE” is not stopped on the payline L as a result of executing the stop control game a predetermined number (for example, ten) of times, which is preset as a control period, the slot machine 10 inactivates the operations for the stop switches 82, and stops the symbol combination of “APPLE” on the payline L by a control from a main CPU 41. Thereafter, the slot machine 10 shifts the current unit game from the stop control game to the bonus game (Step S500).

As the bonus game, there is a mystery bonus, a second game, a free game, or the like. In this embodiment, the free game is mentioned as an example of the bonus game. As shown in FIG. 2, a horizontal straight line displayed on the centers of the display windows 15L, 15C and 15R is set as the payline L. However, in such a construction in which three symbols are displayed on one display window, another straight line (for example, upper line, lower line, or oblique line) may be set as the payline L. Moreover, the payline L is not limited to the straight line. The slot machine 10 may shift the current unit game from the stop control game to the bonus game when one symbol of “APPLE” is displayed on at least one of the display windows.

In this embodiment, the slot machine 10 includes the three reels 14L, 14C and 14R. However, the slot machine 10 may include reels of which number is other than three (for example, one reel or five reels). Moreover, this embodiment can also be applied to a slot machine which employs video reels, as well as to the slot machine which employs mechanical reels.

In this embodiment, the reels 14L, 14C and 14R are rotated in the unit game, thereby presenting the symbols on the display windows 15L, 15C and 15R. However, a mode may be adopted, in which an image of at least one of the symbols presented on the display windows 15L, 15C and 15R is changed to an image of another symbol in the unit game, and the changed image of the symbol is presented thereon one more time.

Next, a description will be made of a construction of the slot machine 10 according to the embodiment of the present invention with reference to FIG. 2. The slot machine 10 is installed in a game arcade.

In the slot machine 10, as game media for executing the unit game, the coins, bills, or electronic valuable information equivalent to the coins or the bills is used. However, in the present invention, medals, tokens, electronic money, or tickets (for example, tickets attached with bar codes) may also be used as the game media besides the coins, the bills, or the electronic valuable information.

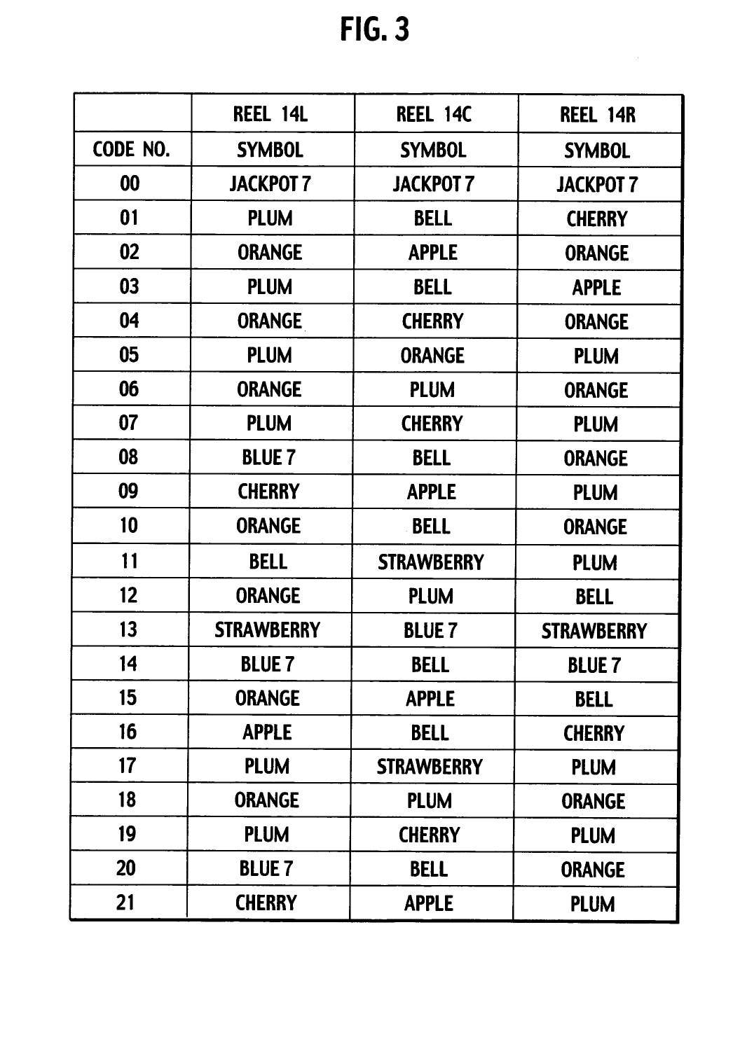

As shown in FIG. 2, the slot machine 10 includes a cabinet 11, a top box 12 installed on the cabinet 11, and a main door 13 provided on a front surface of the cabinet 11. In an inside of the cabinet 11, the reels 14L, 14C and 14R (displays) are rotatably provided. As shown in FIG. 3, on an outer circumferential surface of each of the reels 14L, 14C and 14R, a column of the symbols, which is composed of 22 symbols, is drawn. The reels 14L, 14C and 14R display a symbol matrix formed of a plurality of the columns and a plurality of rows. Note that, though the three rotatable reels are used as the displays in this embodiment, the symbols may be scrolled by using image display devices such as liquid crystal display devices. Moreover, the number of reels is not limited to three.

On the main door 13, a lower image display panel 16 is provided in front of the reels 14L, 14C and 14R. The lower image display panel 16 includes a transparent liquid crystal panel, and during the game, displays a variety of information, effect images and the like regarding the game.

A number-of-credits display portion 31 and a number-of-payouts display portion 32 are provided on the lower image display panel 16. The number of credited coins is displayed as an image on the number-of-credits display portion 31. On the number-of-payouts display portion 32, the number of coins to be paid out in the case where the symbol combination stopped on the payline L to be described later coincides with the winning combination is displayed as an image.

On the lower image display panel 16, the display windows 15L, 15C and 15R through which it is possible to visually recognize the reels 14L, 14C and 14R are formed. Through each display window, three symbols among the symbols drawn on the outer circumferential surface of each reel are presented to the player. On the lower image display panel 16, one payline L which crosses horizontally over the display windows 15L, 15C and 15R is formed. The payline L is a line which defines the symbol combination. When the symbol combination stopped on the payline L coincides with the winning combination, a predetermined number of coins are paid out in response to the stopped symbol combination and the number of inserted coins (number of BETs).

In this embodiment, one payline L is set. However, the payline L which crosses horizontally over the display windows 15L, 15C and 15R and/or paylines L which cross obliquely over the display windows 15L, 15C and 15R may be set. Then, a mode may be adopted, in which the paylines L of which number corresponding to the number of inserted coins are activated, and the predetermined number of coins are paid out in response to the stopped symbol combinations when the symbol combinations stopped on the activated paylines L coincide with the winning combination.

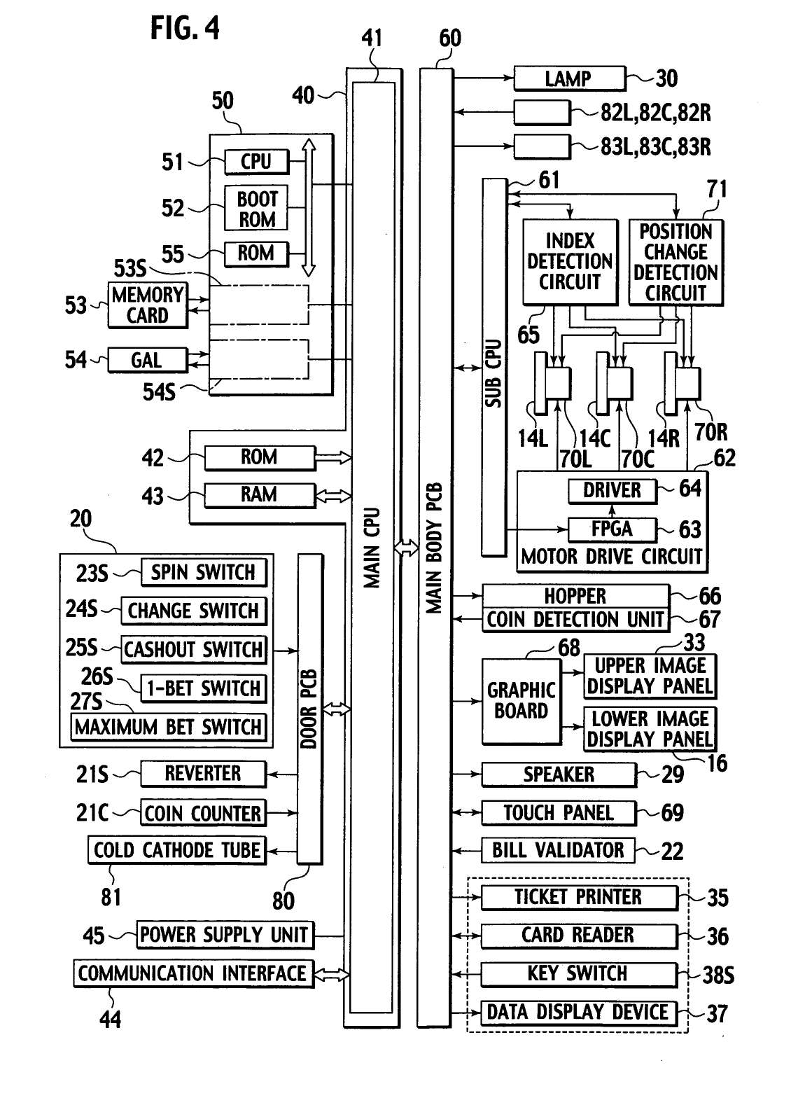

A touch panel 69 (refer to FIG. 4) is provided on a front surface of the lower image display panel 16. The player can input various instructions to the slot machine 10 by operating the touch panel 69.

Below the lower image display panel 16, there are provided a control panel 20 composed of a plurality of buttons 23 to 27 via which the instructions relating to a progress of the game are inputted by the player, the stop switches 82L, 82C and 82R, the coin receiving slot 21 through which the coins are received into the cabinet 11, and a bill validator 22. In this embodiment, the stop switches 82L, 82C and 82R, which correspond to the reels 14L, 14C and 14R, respectively, are provided. However, a transparent touch panel may be disposed in front of the display windows 15L, 15C and 15R, and the touch panel may thus be used instead of the stop switches 82L, 82C and 82R. The touch panel may also be a touch panel employed for a mobile terminal, an ATM of a bank, and the like. Thus, while visually recognizing varying states of the symbols scrolled on the display windows 15L, 15C and 15R, the player can touch, through the touch panel, the symbols desired to be stopped (rearranged) on the display windows 15L, 15C and 15R, thus making it possible to input, to the slot machine 10, instructions to rearrange the symbols. Such a rearrangement operation has an advantage in that the player can perform the operation concerned with a feeling of direct touch to the symbols.

In this embodiment, the stop switches 82L, 82C and 82R, which correspond to the reels 14L, 14C and 14R, respectively, are provided. However, one stop switch which contributes only to rearrangement of the symbol relating to one reel may also be provided. Thus, switching can be made from a play mode concerned with the rearrangement of the symbols relating to all the reels (rearrangement of three reels in this embodiment) to a play mode concerned only with the rearrangement of the symbol relating to one reel in such a manner that the player pushes the stop switch.

On the control panel 20, there are provided the spin button 23, a change button 24, a cashout button 25, the 1-BET button 26, and the maximum-BET button 27. The spin button 23 is a button for inputting, to the slot machine 10, an instruction to start the rotations of the reels 14L, 14C and 14R. The change button 24 is a button for use in the case of requesting change (conversions into small notes) to a clerk of the game arcade. The cashout button 25 is a button for inputting, to the slot machine 10, an instruction to payout the credited coins to a coin tray 18.

The 1-BET button 26 is a button for inputting, to the slot machine 10, an instruction to bet one coin on the current unit game. The maximum-BET button 27 is a button for inputting, to the slot machine 10, an instruction to bet, on the current unit game, the maximum number (for example, 50) of coins capable of being bet on one unit game.

The stop switches 82L, 82C and 82R are switches activated when the stop control game is started, and are for allowing the player to perform the operations for stopping the rotating reels 14L, 14C and 14R. For the stop switches 82L, 82C and 82R, display lamps 83L, 83C and 83R are provided, respectively. As will be described later, when the operations for the stop switches 82L, 82C and 82R are activated, the display lamps 83L, 83C and 83R are turned on, and notify the player that the operations for the stop switches 82L, 82C and 82R are effective. An operation lever, a track ball, a touch panel, or the like can be used instead of the stop switches 82L, 82C and 82R.

The bill validator 22 identifies whether or not the bill is a real one, and receives the real bill into the cabinet 11. The bill validator 22 may also be composed so as to be capable of reading such a bar code-attached ticket 39 to be described later. On a lower front surface of the main door 13 (below the control panel 20), a berry glass 34 on which a character and the like are drawn is provided.

On a front surface of the top box 12, an upper image display panel 33 is provided. The upper image display panel 33 includes a liquid crystal panel, and displays, for example, an effect image, and an image representing an introduction of game contents and an explanation of game rules.

On a side surface of the top box 12, a speaker 29 for outputting sounds is provided. Under the upper image display panel 33, there are provided a ticket printer 35, a card reader 36, a data display device 37, and a keypad 38. The ticket printer 35 prints, on a ticket, a bar code in which data regarding the number of credits, date, an identification number of the slot machine 10, and the like is encoded. Then, the ticket printer 35 outputs the printed ticket as the bar code-attached ticket 39. The player can play a game on another slot machine by using the bar code-attached ticket 39, and can exchange the bar code-attached ticket 39 with bills and the like at a cashier and the like of the game arcade.

The card reader 36 reads data from a smart card, and writes data to the smart card. The smart card is a card possessed by the player, and stores, for example, data for identifying the player and data regarding a history of the games played by the player.

The data display unit 37 is composed of a fluorescent display or the like, and displays, for example, the data read by the card reader 36 and data inputted by the player through the keypad 38. The keypad 38 is used for inputting an instruction and data regarding issuance of the ticket, and so on. On each outer circumferential surface of the reel 14L (left reel), the reel 14C (center reel), and the reel 14R (right reel), 22 symbols are drawn. The columns of the symbols drawn on the reels 14L, 14C and 14R are different from one another. Each column of the symbols is composed by combining symbols of “JACKPOT 7”, “BLUE 7”, “BELL”, “CHERRY”, “STRAWBERRY”, “PLUM”, “ORANGE”, and “APPLE”.

With regard to the symbols of “JACKPOT 7”, “BLUE 7”, “BELL”, “CHERRY”, “STRAWBERRY”, “PLUM”, and “ORANGE”, when the same three symbols thereof are stopped on the payline L, a predetermined number of the credits are added to the credits owned by the player (refer to FIG. 9). With regard to the symbols of “CHERRY” and “ORANGE”, even if one symbol thereof or the same two symbols thereof are stopped on payline L, a predetermined number of the credits are added to the credits owned by the player in response to the number of stopped symbols.

The symbol of “APPLE” is a symbol which establishes the bonus game trigger (symbol for shifting a gaming mode to the bonus game). When three symbols of “APPLE” are stopped on the payline L, the slot machine 10 shifts the gaming mode from the base game to the bonus game. In this embodiment, the “APPLE” is a symbol which forms a specific combination.

The bonus game has a gaming mode more advantageous than the base game. In this embodiment, the bonus game is a free game (game which makes it possible to play the games a predetermined number of times without betting the coins). The bonus game may be any game as long as it offers the gaming mode more advantageous than that of the base game for the player. For example, such an advantageous gaming mode can include a state where it is possible to acquire more game media than in the base game, a state where it is possible to acquire the game media at a higher probability than that of the base game, a state where the number of consumed game media becomes smaller than in the base game, and the like. Specifically, the bonus game can include the free game, the second game, and the like.

The reels 14L, 14C and 14R start to be rotated, when the 1-BET button 26 or the maximum-BET button 27 is pushed and then the spin button 23 is pushed. As the reels 14L, 14C and 14R are being rotated, the symbols drawn on the outer circumferential surfaces of the reels 14L, 14C and 14R are scrolled on the display windows 15 downward from the above. Then, after an elapse of a predetermined time, the rotations of the reels 14L, 14C and 14R are stopped. At this time, through each display window, the player visually recognizes some symbols among the symbols drawn on the outer circumferential surface of each reel. A game from the start of the rotations of the reels 14L, 14C and 14R to the subsequent stop thereof is the unit game. Specifically, a game from scrolling of the symbols arranged on the displays to rearrangement thereof is the unit game.

As shown in FIG. 9, a variety of winning combinations are predetermined. When the symbol combination serving as the winning combination is stopped on the payline L, the paid-out coins of which number corresponding to the stopped winning combination is added to the credits owned by the player. When the bonus game trigger is established, that is, when three symbols of “APPLE” are stopped on the payline L, the gaming mode is shifted from the base game to the bonus game.

Next, a description will be made of a configuration of a control circuit of the slot machine 10 according to the embodiment of the present invention. As shown in FIG. 4, the control circuit is composed of a mother board 40, a main body printed circuit board (PCB) 60, a gaming board 50, a sub CPU 61, a door PCB 80, various switches, and various sensors.

The gaming board 50 includes a central processing unit (CPU) 51, a boot ROM 52, a ROM 55, a card slot 53S corresponding to a memory card 53, and an IC socket 54S corresponding to a generic array logic (GAL) 54. The CPU 51, the boot ROM 52, and the ROM 55 are interconnected through an internal bus.

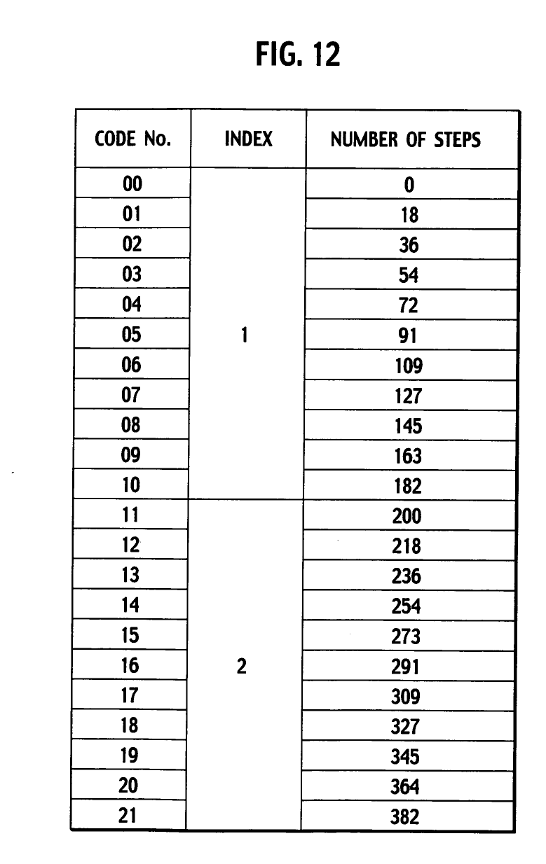

The memory card 53 stores a game program and a game system program. The game program includes a lottery program. The lottery program is a program for deciding code numbers corresponding to the symbols to be stopped on the payline L for each reel. The lottery program includes pieces of symbol weighting data, which individually correspond to plural types of payout rates (for example, 80%, 84%, and 88%). The symbol weighting data is data representing a correspondence relationship between the code number (refer to FIG. 12) of each symbol and one or a plurality of random number values belonging to a predetermined numeric value range (0 to 256) for each reel.

The payout rates are the ones determined based on payout rate setting data outputted from the GAL 54. The lottery is performed based on the symbol weighting data corresponding to the payout rate.

The card slot 53S is composed so as to make it possible to insert the memory card 53 thereinto and to detach the memory card 53 therefrom. The card slot 53S is connected to the mother board 40 by an IDE bus. Hence, a type and contents of the game played in the slot machine 10 can be changed in the following manner. Specifically, for the purpose of changing the type and the contents, the memory card 53 is detached from the card slot 53S, another game program and another game system program are written to the detached memory card 53, and the memory card 53 to which the programs are written is inserted into the card slot 53S.

The game program includes a program relating to the progress of the game, a program for shifting the gaming mode to the bonus game, and image data and sound data, which are outputted during the game. Moreover, the game program includes image data and sound data, which constitute notification data for notifying the player that the stopping operations for the reels 14L, 14C and 14R by the stop switches 82L, 82C and 82R are possible when the bonus game is won and the bonus game trigger is not established.

The GAL 54 includes a plurality of input ports, and an output port. When data is inputted to one input port, the GAL 54 outputs, from the output port, data corresponding to the inputted data. The outputted data is the payout rate setting data.

The IC socket 54S is composed so as to make it possible to attach the GAL 54 thereto and to detach the GAL 54 therefrom. The IC socket 54S is connected to the mother board 40 by a PCI bus. Hence, the payout rate setting data outputted from the GAL 54 can be changed in the following manner. Specifically, for the purpose of changing the payout rate setting data, the GAL 54 is detached from the IC socket 54S, a program stored in the detached GAL 54 is rewritten, and the GAL 54 in which the program is rewritten is attached to the IC socket 54S.

The CPU 51, the ROM 55, and the boot ROM 52 are connected to the mother board 40 through the PCI bus. The PCI bus transfers a signal between the mother board 40 and the gaming board 50, and supplies power from the mother board 40 to the gaming board 50. The ROM 55 stores country identification information and an authentication program. The boot ROM 52 stores a preliminary authentication program, a program (boot code) for allowing the CPU 51 to activate the preliminary authentication program, and the like.

The authentication program is a program (tampering check program) for authenticating the game program and the game system program. The authentication program is a program for verifying and proving that the game program and the game system program are not tampered with. Specifically, the authentication program is described in accordance with a procedure of authenticating the game program and the game system program. The preliminary authentication program is a program for authenticating the above-described authentication program. The preliminary authentication program is described in accordance with a procedure of proving that the authentication program to be subjected to the authentication process is not tampered with, that is, of authenticating the authentication program.

The mother board 40 includes a main CPU 41 (controller), a read only memory (ROM) 42, a random access memory (RAM) 43, and a communication interface 44.

The main CPU 41 has a function as a controller which controls the entirety of the slot machine 10. In particular, when the spin button 23 is pushed in a state where the credits are bet, the main CPU 41 performs the following controls, which are: a control to output, to a motor drive circuit 62, an instruction signal for rotating stepping motors 70L, 70C and 70R; a control to decide the symbols to be stopped on the payline L provided on the display windows 15L, 15C and 15R after the reels 14L, 14C and 14R are rotated; and a control to stop the reels 14L, 14C and 14R so as to stop the decided symbols on the payline L. The main CPU 41 has a function as an arrangement controller. After the plurality of symbols displayed on the displays are scrolled, the main CPU 41 as the arrangement controller executes an arrangement control to select arrayed symbols from among the plural types of symbols, and to stop the reels so as to display the selected symbols on the displays, in order to rearrange the arrayed symbols, which constitute the symbol matrix, as a new symbol matrix.

Moreover, the main CPU 41 has a function as a stop switch controller. When the symbol combination arranged on the payline L coincides with the specific combination with regard to the symbol matrix displayed on the displays, the main CPU 41 as the stop switch controller activates the stop switches 82L, 82C and 82R, and stops the scroll for rearranging the symbol matrix displayed on the displays in response to input timing of the stop switches 82L, 82C and 82R by the player.

The ROM 42 stores a program such as a base input/output system (BIOS) executed by the main CPU 41, and data used permanently. Upon executing the BIOS, the main CPU 41 performs an initialization process for the respective peripheral devices, and starts a reading process for the game program and the game system program, which are stored in the memory card 53, through the gaming board 50.

The RAM 43 stores data and programs for use when the main CPU 41 performs the process. Moreover, the RAM 43 has an area which stores a variable “n” indicating the number of times that the stop control game to be described later is executed.

The communication interface 44 communicates with a host computer and the like, which are installed in the game arcade, through a communication line.

The mother board 40 is connected to the main body PCB 60 and the door PCB 80 though a universal serial bus (USB). Moreover, the mother board 40 is connected to a power supply unit 45. When the power is supplied from the power supply unit 45 to the mother board 40, the main CPU 41 of the mother board 40 is activated. Moreover, the power is supplied to the gaming board 50 through the PCI bus, and the CPU 51 is thus activated.

The main body PCB 60 and the door PCB 80 are connected to instruments and devices, which generate input signals inputted to the main CPU 41, and to instruments and devices, in which actions are controlled by control signals outputted from the main CPU 41. The main CPU 41 executes the game program and the game system program, which are stored in the RAM 43, based on the input signals inputted to the main CPU 41 concerned, and stores a result of the execution in the RAM 43, or transmits the control signals to the respective instruments and devices.

The main body PCB 60 is connected to a lamp 30, the sub CPU 61, a hopper 66, a coin detection unit 67, a graphic board 68, the speaker 29, the touch panel 69, the bill validator 22, the ticket printer 35, the card reader 36, a key switch 38S, and the data display device 37. Moreover, the main body PCB 60 is connected to the stop switches 82L, 82C and 82R, and the display lamps 83L, 83C and 83R provided on the stop switches 82L, 82C and 82R concerned.

The lamp 30 is turned on or turned off based on the control signal outputted from the main CPU 41.

The sub CPU 61 is connected to the motor drive circuit 62, and controls the reels 14L, 14C and 14R to be rotated and stopped. The motor drive circuit 62 includes a field programmable gate array (FPGA) 63, and a driver 64. The FPGA 63 is a programmable electronic circuit such as an LSI, and functions as a control circuit for the stepping motors 70L, 70C and 70R. The driver 64 functions as an amplifier circuit of pulses inputted to the stepping motors 70L, 70C and 70R.

The motor drive circuit 62 is connected to the stepping motors 70L, 70C and 70R which rotate the reels 14L, 14C and 14R. In this embodiment, 1-2 phase excitation stepping motors are used as the stepping motors.

Moreover, the sub CPU 61 is connected to an index detection circuit 65, and a position change detection circuit 71. The index detection circuit 65 detects positions (indices to be described later) of the rotating reels 14L, 14C and 14R, and synchronization losses of the reels 14L, 14C and 14R. Note that the rotation and stop control for the reels 14L, 14C and 14R will be described later in detail by using the drawings.

The position change detection circuit 71 detects changes of the stopped positions of the reels 14L, 14C and 14R after the rotations of the reels 14L, 14C and 14R are stopped. For example, the position change detection circuit 71 detects the changes of the stopped positions of the reels 14L, 14C and 14R when the player forcibly changes the stopped positions of the reels 14L, 14C and 14R so as to arrange the winning combination on the payline L though the symbol combination arranged on the payline L does not coincide with the winning combination.

The hopper 66 is installed in the cabinet 11, and pays out a predetermined number of coins from a coin payout opening 19 to the coin tray 18 based on the control signal outputted from the main CPU 41. The coin detection unit 67 is provided in an inside of the coin payout opening 19. When the number of coins paid out from the coin payout opening 19 reaches a predetermined number, the coin detection unit 67 outputs an input signal to the main CPU 41.

The graphic board 68 controls displays of images on the upper image display panel 33 and/or the lower image display panel 16 based on the control signal outputted from the main CPU 41. The number-of-credits display portion 31 of the lower image display panel 16 displays the number of credits, which is stored in the RAM 43. The number-of-payouts display portion 32 of the lower image display panel 16 displays the number of paid-out coins. The graphic board 68 includes a video display processor (VDP) which generates image data based on the control signal outputted from the main CPU 41, a video RAM which temporarily stores the image data generated by the VDP, and the like.

The bill validator 22 reads an image of the bill, and receives a real bill into the cabinet 11. Upon receiving the real bill, the bill validator 22 outputs an input signal to the main CPU 41 based on an amount of the received bill. The main CPU 41 stores the number of credits, which corresponds to the amount of bill, in the RAM 43. In this case, the amount of bill is transmitted by the input signal.

Based on the control signal outputted from the main CPU 41, the ticket printer 35 prints, on the ticket, the bar code in which the data regarding the number of credits, the date, the identification number of the slot machine 10, and the like, which are stored in the RAM 43, is encoded. Then, the ticket printer 35 outputs the printed ticket as the bar code-attached ticket 39.

The card reader 36 reads the data from the smart card, and then transmits the read data to the main CPU 41. Moreover, the card reader 36 writes the data to the smart card based on the control signal from the main CPU 41. The key switch 38S is provided on the keypad 38, and outputs an input signal to the main CPU 41 when the keypad 38 is operated by the player.

The data display device 37 displays the data read by the card reader 36 and the data inputted by the player through the keypad 38 based on the control signal outputted from the main CPU 41.

The stop switches 82L, 82C and 82R are used in the case of stopping the rotating reels 14L, 14C and 14R when the stop control game is executed. When the bonus game is won, the stop switches 82L, 82C and 82R are activated, and the display lamps 83L, 83C and 83R are thus turned on. Then, when the player pushes the stop switches 82L, 82C and 82R, the main CPU 41 stops the rotating reels 14L, 14C and 14R at the time when the player pushes the respective stop switches.

The door PCB 80 is connected to the control panel 20, a reverter 21S, a coin counter 21C, and a cold cathode tube 81. The control panel 20 includes a spin switch 23S corresponding to the spin button 23, a change switch 24S corresponding to the change button 24, a cashout switch 25S corresponding to the cashout button 25, a 1-BET switch 26S corresponding to the 1-BET button 26, and a maximum-BET switch 27S corresponding to the maximum BET button 27. The respective switches output input signals to the main CPU 41 when the player pushes the buttons corresponding to the respective switches concerned.

The coin counter 21C is provided in an inside of the coin receiving slot 21, and identifies whether or not the coins inserted into the coin receiving slot 21 by the player are real ones. Coins other than the real coins are discharged from the coin payout opening 19. Moreover, upon detecting the real coins, the coin counter 21C outputs an input signal to the main CPU 41.

Based on the control signal outputted form the main CPU 41, the reverter 21S distributes the coins recognized as the real coins by the coin counter 21C to a cash box (not shown) installed in an inside of the slot machine 10 or to the hopper 66. When the hopper 66 is filled with the coins, the real coins are distributed to the cash box by the reverter 21S. Meanwhile, when the hopper 66 is not filled with the coins, the real coins are distributed to the hopper 66 by the reverter 21S.

The cold cathode tube 81 is installed on backsides of the lower image display panel 16 and the upper image display panel 33, and functions as a backlight. The cold cathode tube 81 is turned on based on the control signal outputted from the main CPU 41.

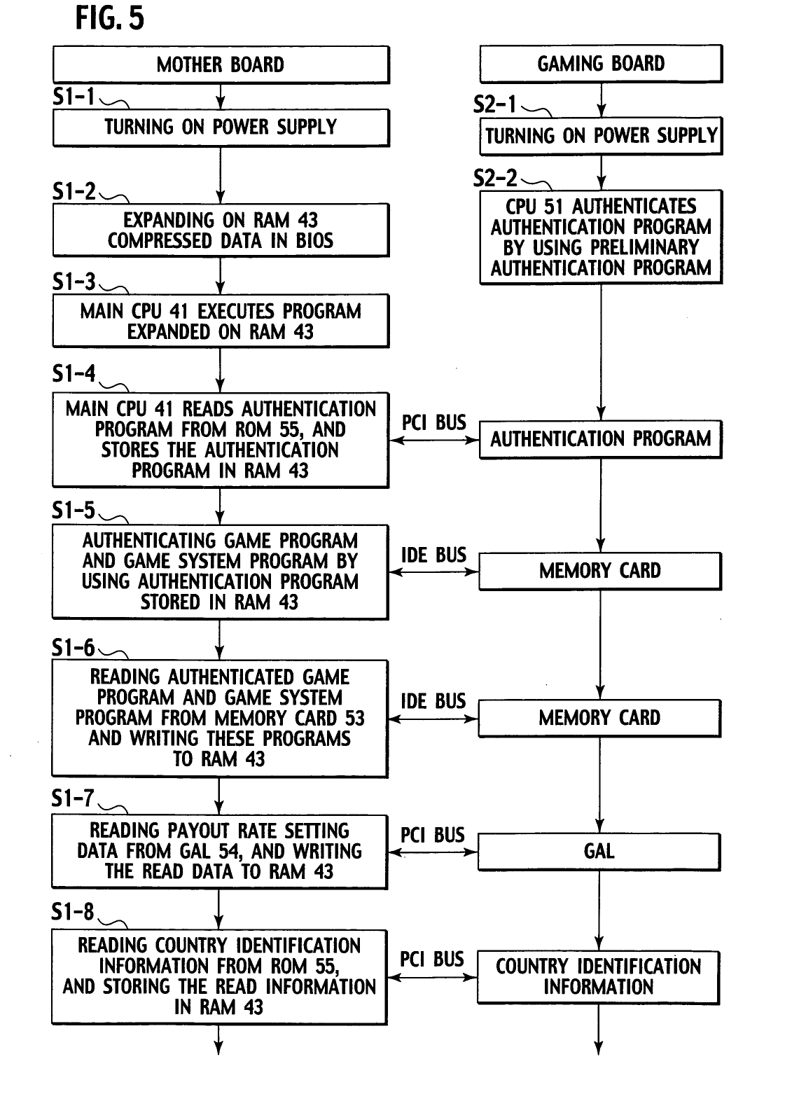

Next, with reference to FIG. 5, a description will be made of the procedure (Step S100 in FIG. 1) of the authentication/reading process for the game program and the game system program, which is performed between the mother board 40 and the gaming board 50. It is assumed that the memory card 53 is attached to the card slot 53S of the gaming board 50, and that the GAL 54 is attached to the IC socket 54S of the gaming board 50.

When the power supply switch is turned on in the power supply unit 45, the mother board 40 and the gaming board 50 are activated (Steps S1-1, S2-1). When the mother board 40 and the gaming board 50 are activated, mutually different processes are simultaneously performed in the mother board 40 and the gaming board 50. In the gaming board 50, the CPU 51 reads out the preliminary authentication program stored in the boot ROM 52. Then, before the authentication program is captured to the mother board 40, the CPU 51 verifies and proves that the authentication program is not tampered with in advance in accordance with the read-out preliminary authentication program (Step S2-2).

In the mother board 40, the main CPU 41 executes the BIOS stored in the ROM 42, and expands, on the RAM 43, compressed data incorporated in the BIOS (Step S1-2). Then, the main CPU 41 executes the BIOS expanded on the RAM 43, and diagnoses and initializes the variety of peripheral devices (Step S1-3).

The main CPU 41 reads out, through the PCI bus, the authentication program stored in the ROM 55, and stores the read-out authentication program in the RAM 43 (Step S1-4).

The main CPU 41 accesses, through the IDE bus, the memory card 53 attached to the card slot 53S. Then, the main CPU 41 reads out the game program and the game system program, which are stored in the memory card 53.

In accordance with the authentication program stored in the RAM 43, the main CPU 41 verifies and proves that the read-out game program and game system program are not tampered with (Step S1-5).

When the authentication process is ended normally, the main CPU 41 stores the authenticated game program and game system program in the RAM 43 (Step S1-6). Next, the main CPU 41 accesses, through the PCI bus, the GAL 54 attached to the IC socket 54S, reads the payout rate setting data from the GAL 54, and stores the read payout rate setting data in the RAM 43 (Step S1-7). Next, the main CPU 41 reads out, through the PCI bus, the country identification information stored in the ROM 55 of the gaming board 50, and stores the read-out country identification information in the RAM 43 (Step S1-8).

After performing a series of the above-described processes, the main CPU 41 sequentially reads out and executes the game program and the game system program, and progresses the base game.

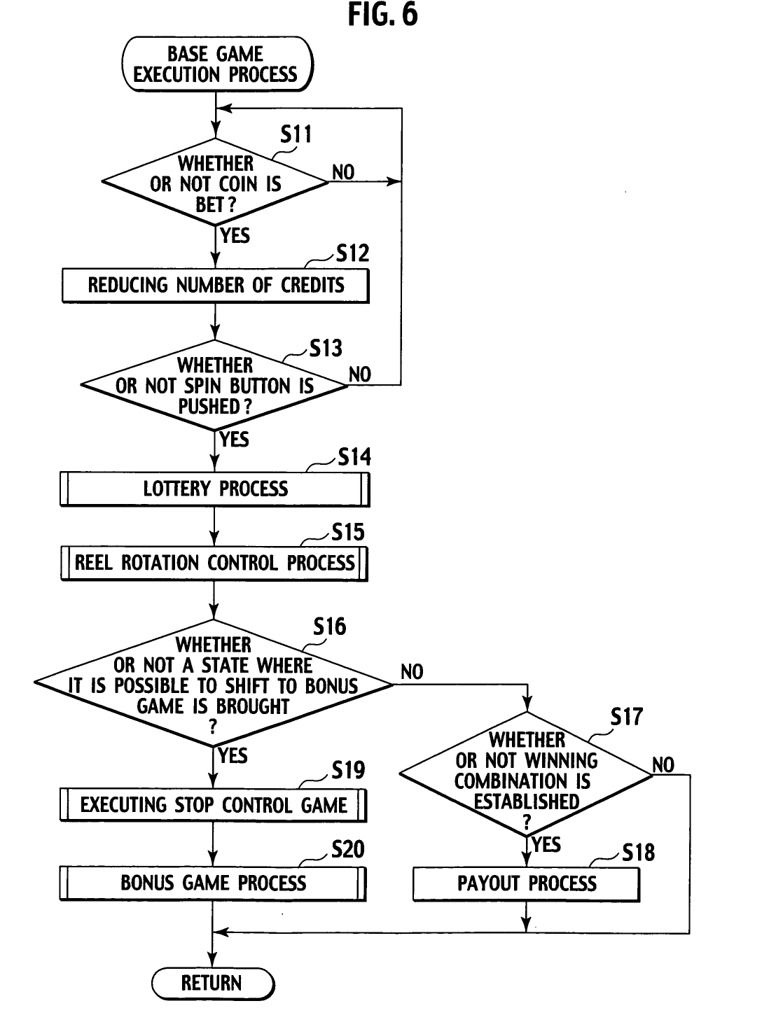

Next, a description will be made of the procedure (Step S200 in FIG. 1) of the execution process for the base game with reference to FIG. 6.

The main CPU 41 determines whether or not the coin is bet (Step S11). Specifically, the main CPU 41 determines whether or not to have received the input signal outputted from the 1-BET switch 26S when the 1-BET button 26 is pushed or the input signal outputted from the maximum-BET switch 27S when the maximum-BET button 27 is pushed. When the coin is not bet, the main CPU 41 remains at Step S11.

When the coin is bet, the main CPU 41 reduces the number of credits, which is stored in the RAM 43, in response to the number of bet coins (Step S12). Note that, when the number of bet coins is larger than the number of credits, which is stored in the RAM 43, the main CPU 41 remains at Step S11 without performing the process for reducing the number of credits, which is stored in the RAM 43. Moreover, when the number of bet coins exceeds an upper limit value (50 in this embodiment) of the coins capable of being bet on one unit game, the main CPU 41 proceeds to Step S13 without performing the process for reducing the number of credits, which is stored in the RAM 43. When the main CPU 41 proceeds to Step S13, the reels 14L, 14C and 14R turn into a state where it is possible to start the rotations thereof.

Next, the main CPU 41 determines whether or not the spin button 23 is pushed (Step S13). When the spin button 23 is pushed, the main CPU 41 determines whether or not to have received the input signal outputted from the spin switch 23S.

When the spin button 23 is not pushed, the main CPU 41 returns to Step S11. Note that, when the spin button 23 is not pushed (for example, when an instruction to the effect that the game is to be ended is inputted without the push of the spin button 23), the main CPU 41 cancels a result of the reduction in Step S12.

In this embodiment, after the coin is bet (Step S11), the main CPU 41 performs the process for reducing the number of credits (Step S12) before determining whether or not the spin button 23 is pushed (Step S13). Note that the present invention is not limited to a series of the above-described processes. For example, the above-described processes may be performed in the following order. First, the coin is bet (Step S11), and then the main CPU 41 determines whether or not the spin button 23 is pushed (Step S13). When the spin button 23 is pushed (YES in step S13), the main CPU 41 performs the process for reducing the number of credits (Step S12).

When the spin button 23 is pushed, the main CPU 41 performs the lottery process (Step S14). In the lottery process, the main CPU 41 executes the lottery program stored in the RAM 43, and decides the code numbers of the symbols to be stopped on the payline L at the time when the reels 14L, 14C and 14R are stopped. Thus, the main CPU 41 decides the symbol combination to be stopped on the payline L. Note that, in this embodiment, a description will be made of the case where the main CPU 41 decides the symbol combination to be stopped on the payline L, and determines whether or not the decided winning combination coincides with one winning combination among the plural types of winning combinations. However, the present invention is not limited to this case. For example, the main CPU 41 may select one winning combination from among the plural types of winning combinations based on the lottery, and may decide the symbol combination to be stopped on the payline L based on the selected winning combination.

Next, the main CPU 41 performs a rotation control process for the reels (Step S15). Specifically, after starting the rotations of the reels 14L, 14C and 14R, the main CPU 41 stops the rotations of the reels 14L, 14C and 14R so that the symbol combination decided in Step S14 can be stopped on the payline L.

Next, the main CPU 41 determines whether or not the bonus game is won by the lottery process and a state where it is possible to shift to the bonus game is brought (Step S16).

When the state where it is possible to shift to the bonus game is not brought (NO in Step S16), the main CPU 41 determines whether or not the symbol combination arranged on the payline L coincides with the winning combination (Step S17). When the symbol combination coincides with the winning combination (YES in Step S17), the main CPU 41 pays out the coins of which number corresponding to the number of bet coins and the winning combination (Step S18). In the case of reserving the paid-out coins, the main CPU 41 adds a predetermined number of credits to the number of credits, which is stored in the RAM 43. In the case of paying out the coins, the main CPU 41 transmits the control signal to the hopper 66, and pays out a predetermined number of the coins. At this time, the coin detection unit 67 counts the number of coins paid out from the hopper 66, and when a value of the counting reaches a designated number, transmits a payout complete signal to the main CPU 41. Thus, the main CPU 41 stops driving the hopper 66, and ends the payout process for the coins.

When the symbol combination does not coincide with the winning combination (NO in Step S17), or when the main CPU 41 executes the process of Step S18, the execution process for the base game is ended.

When the state where it is possible to shift to the bonus game is brought (YES in Step S16), the main CPU 41 sets a state where it is possible to arrange the symbols of “APPLE” serving as the triggers for establishing the bonus game on the payline L. Then, the main CPU 41 executes the stop control game (Step S19; Step S400 in FIG. 1) and the bonus game process (Step S20; Step S500 in FIG. 1).

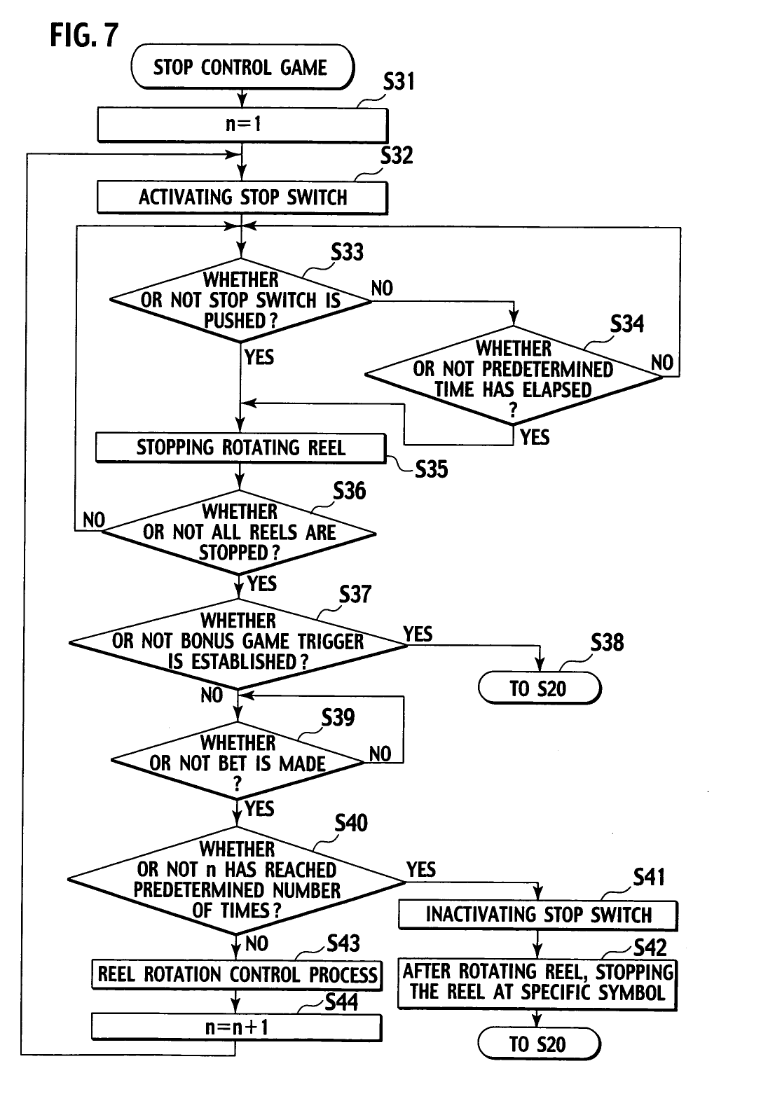

Next, a description will be made of the procedure of the execution process for the stop control game with reference to FIG. 7.

The main CPU 41 sets, at “1”, a value of the variable “n” indicating the number of times that the stop control game is executed (Step S31). The value of the variable “n” is stored in the RAM 43. The main CPU 41 activates the stop switches 82L, 82C and 82R (Step S32). Specifically, by pushing the stop switches 82L, 82C and 82R, the rotating reels 14L, 14C and 14R are set in a state possible to be stopped.

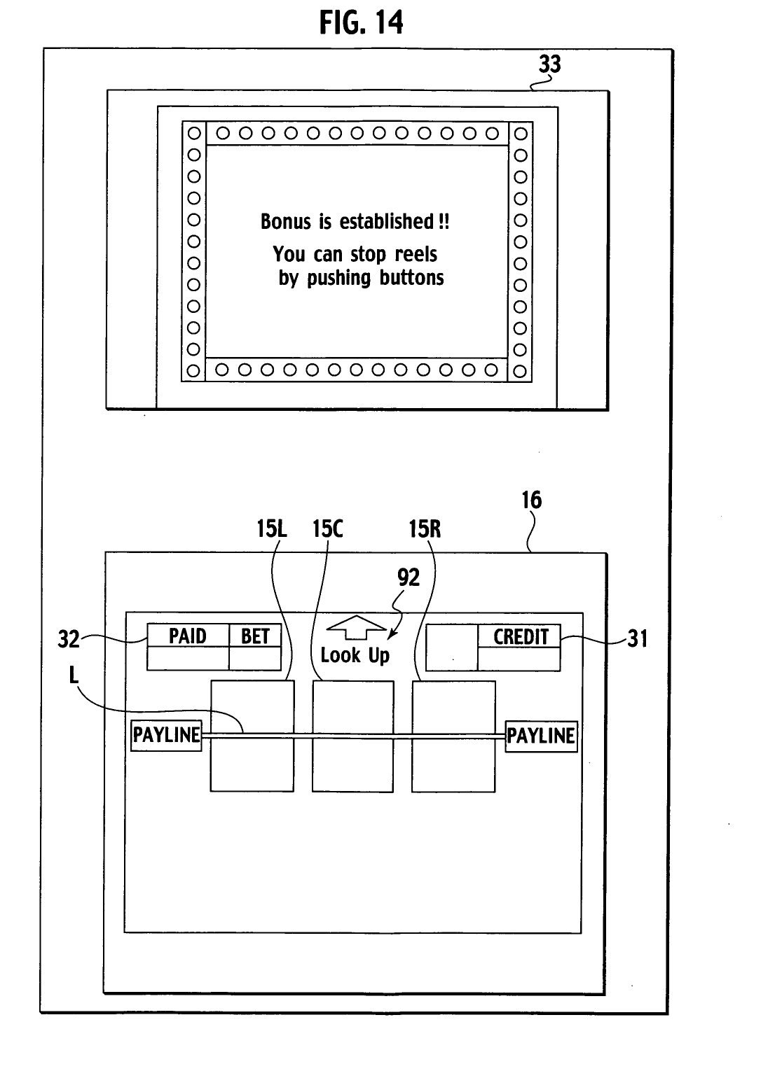

At this time, in order to notify the player that it is possible to operate the stop switches 82L, 82C and 82R, the main CPU 41 displays characters that say “Bonus is established!! You can stop the reels by pushing the buttons.” on the upper image display panel 33 as shown in FIG. 14. Moreover, the main CPU 41 turns on the display lamps 83L, 83C and 83R.

Next, the main CPU 41 determines whether or not the stop switches 82L, 82C and 82R are pushed (Step S33). When the stop switches 82L, 82C and 82R are pushed (YES in Step S33), the main CPU 41 stops the reels 14 corresponding to the pushed stop switches (Step S35).

Specifically, upon receiving sensing signals from sensing sensors (not shown) provided in the respective stop switches and sensing that the stop switches are pushed, the main CPU 41 stops the reels 14 corresponding to the pushed stop switches.

Moreover, the main CPU 41 controls the stopped positions of the reels 14L, 14C and 14R so that it can become possible for the symbols of “APPLE” serving as the triggers for establishing the bonus game to be stopped on the payline L provided on the display windows 15L, 15C and 15R. Thus, the player can rearrange the scrolled symbols in the specific combination.

Hence, in the case where the symbols of “APPLE” drawn on the outer circumferential surfaces of the respective rotating reels are present on the payline L or the vicinity of the upper side of the payline L, when the respective stop switches are pushed by the player, the symbols of “APPLE” of the reels corresponding thereto are stopped on the payline L. When three symbols of “APPLE” on the reels 14L, 14C and 14R are stopped on the payline L, the bonus game trigger is established.

Meanwhile, in the case where the symbols of “APPLE” drawn on the outer circumferential surfaces of the respective rotating reels are not present on the payline L or the vicinity of the upper side of the payline L, when the respective stop switches are pushed by the player, symbols of the reels corresponding thereto, which are other than “APPLE”, are stopped on the payline L. In this case, the bonus game trigger is not established. Moreover, when the symbols other than “APPLE” are stopped on the payline L, the main CPU 41 controls the stopped positions of the reels 14L, 14C and 14R so that a symbol combination which does not coincide with the winning combination shown in FIG. 9 can be arranged on the payline L.

When the stop switches 82L, 82C and 82R are not pushed even if the predetermined time has elapsed (YES in Step S34), the main CPU 41 stops the reels 14L, 14C and 14R in a similar way to the case where the stop switches 82L, 82C and 82R are pushed (Step S35).

Next, the main CPU 41 determines whether or not the reels 14L, 14C and 14R are stopped (Step S36). When the reels 14L, 14C and 14R are not stopped (NO in Step S36), the main CPU 41 returns to Step S33. When the reels 14L, 14C and 14R are stopped (YES in Step S36), the main CPU 41 determines whether or not the bonus game trigger is established (Step S37). Specifically, when the reels 14L, 14C and 14R are stopped, the main CPU 41 determines whether or not the three symbols stopped on the payline L are “APPLE”.

When the bonus game trigger is established (YES in Step S37), the main CPU 41 proceeds to Step S20 in FIG. 6.

Meanwhile, when the bonus game trigger is not established (NO in Step S37), the main CPU 41 determines whether or not the 1-BET button 26 or the maximum-BET button 27 is pushed (Step S39). When the 1-BET button 26 or the maximum-BET button 27 is pushed (YES in Step S39), the main CPU 41 determines whether or not the number of times (stored as the variable “n” in the RAM 43) that the stop control game is executed at this point of time has reached a predetermined number of times (for example, ten times) (Step S40).

When the number of times that the stop control game is executed does not reach the predetermined number of times (NO in Step S40), the main CPU 41 executes the rotation control process for the reels 14L, 14C and 14R without performing the reduction of the number of credits, which is caused by pushing the 1-BET button 26 or the maximum-BET button 27 (Step S43). Specifically, when the BET button 26 or 27 is pushed by the player after the reels 14L, 14C and 14R are stopped, the main CPU 41 rotates the reels 14L, 14C and 14R one more time without consuming the number of credits or receiving the input signal from the spin switch 23S.

Next, the main CPU 41 increases, by one, the value of the variable “n” stored in the RAM 43 (Step S44). In this case, the main CPU 41 displays an image of the value of the variable “n” on the upper image display panel 33, and outputs a sound corresponding to the value of the variable “n” from the speaker 29, thereby notifying the player of the repeated number of times that the stop control game is executed. Thereafter, the main CPU 41 returns to Step S32.

In this embodiment, the upper limit value (for example, 10) of the number of times that the stop control game is executed is set as a limited period of the stop control game. However, besides the above, an upper limit value (for example, 5 minutes) of an execution time of the stop control game may also be set.

Meanwhile, when the number of times that the stop control game is executed reaches the predetermined number (for example, 10) (YES in Step S40), that is, when the symbol combination of “APPLE” is not stopped on the payline L as a result of executing the stop control game the predetermined number of times, the main CPU 41 inactivates the operations for the stop switches 82L, 82C and 82R (Step S41).

Next, the main CPU 41 rotates the reels 14L, 14C and 14R, and stops the reels 14L, 14C and 14R so that the symbol combination of “APPLE” which establishes the bonus game trigger can be arranged on the payline L (Step S42). Then, the main CPU 52 proceeds to Step S20 in FIG. 6.

In the process of Step S39, when the 1-BET button 26 or the maximum-BET button 27 is pushed, the main CPU 41 rotates the reels 14L, 14C and 14R and executes the next stop control game without consuming the number of credits. However, in a similar way to the base game, the main CPU 41 may consume the credits when the 1-BET button 26 or the maximum-BET button 27 is pushed, and may pay out the number of consumed credits every time when the unit game is ended.

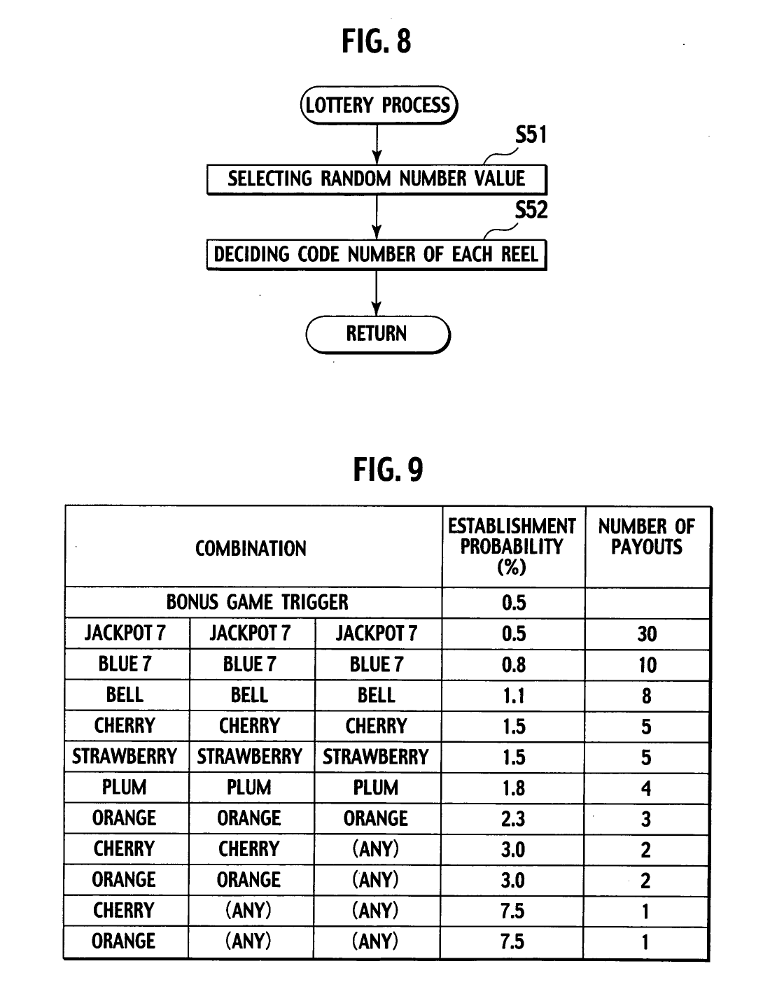

Next, with reference to FIG. 8, a description will be made of the procedure of the lottery process shown in Step S14 in FIG. 6.

The main CPU 41 performs the lottery process by executing the lottery program stored in the RAM 43.

The main CPU 41 executes a random number generating program included in the lottery program, and selects three random number values individually corresponding to the reels 14L, 14C and 14R from among a numeric value range 0 to 255 (Step S51).

Next, the main CPU 41 refers to the symbol weighting data corresponding to the payout rate setting data outputted from the GAL 54 and stored in the RAM 43, and decides the code numbers (refer to FIG. 3) of the reels 14L, 14C and 14R based on the selected three random number values (Step S52). The code numbers of the reels 14L, 14C and 14R individually correspond to the code numbers of the three symbols statically displayed on the payline L. The main CPU 41 decides the code numbers of the respective reels, thereby deciding the winning combination. For example, when the code numbers of the reels 14L, 14C and 14R are decided to be “00”, “00” and “00”, the main CPU 41 decides that the winning combination is “JACKPOT 7”. The main CPU 41 performs the rotation control process shown in Step S15 in FIG. 6 based on the decided code numbers of the reels 14L, 14C and 14R.

A description will be made of the winning combination. An establishment probability of each winning combination shown in FIG. 9 has a numeric value when the payout rate in the other games than the bonus game is 88%.

The establishment probability of the bonus game trigger is 0.5%. When the bonus game is won, the main CPU 41 starts, by the operation of the player, the stop control game capable of stopping the symbol of “APPLE”, which establishes the bonus game trigger, on the payline L. When the symbol combination of “APPLE” is stopped on the payline L by executing the stop control game, the bonus game trigger is established. When the bonus game trigger is established, the main CPU 41 executes the bonus game, and executes the free game the number of times, which is determined by the lottery.

The establishment probability of “JACKPOT 7” is 0.5%. When this winning combination is established, three symbols of “JACKPOT 7” are stopped on the payline L. The main CPU 41 pays out 30 coins per inserted coin. Note that the number of payouts is set larger as the establishment probability of the winning combination is lower. When the symbol combination that does not coincide with any winning combination is stopped on the payline L, the main CPU 41 does not pay out the coins.

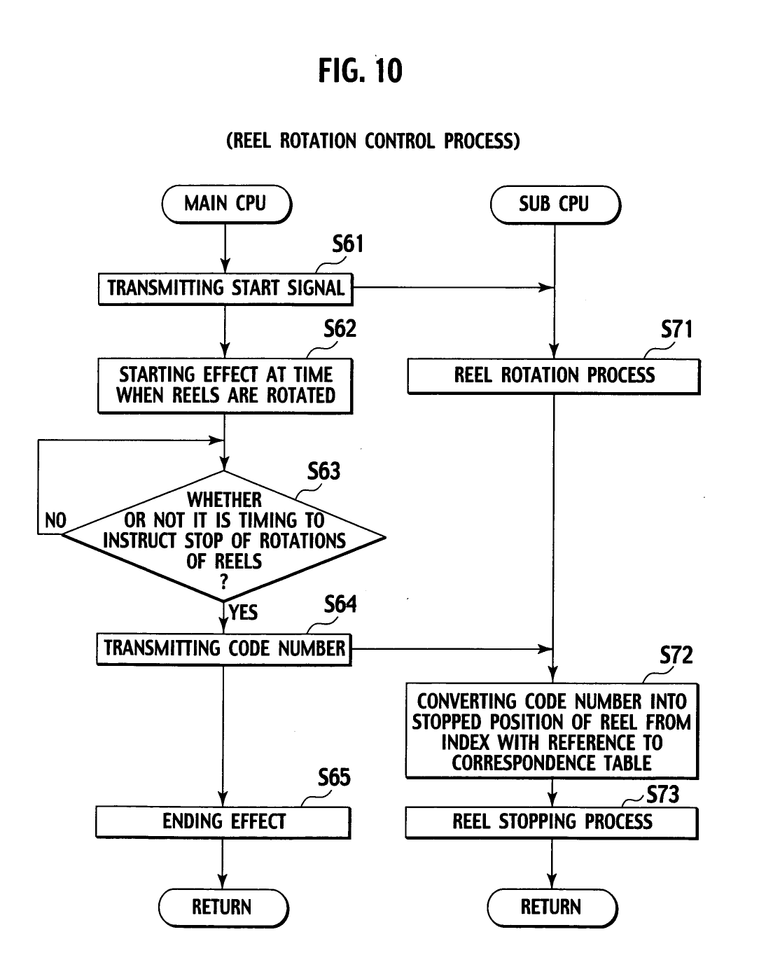

Next, with reference to FIG. 10, a description will be made of the procedure of the reel rotation control process shown in Step S15 in FIG. 6. This process is performed between the main CPU 41 and the sub CPU 61.

The main CPU 41 transmits, to the sub CPU 61, a start signal for starting the rotations of the reels 14L, 14C and 14R (Step S61). Upon receiving the start signal from the main CPU 41, the sub CPU 61 performs the reel rotation process (Step S71). In this process, the sub CPU 61 supplies the pulses to the motor drive circuit 62. The pulses outputted from the motor drive circuit 62 are amplified by the driver 64, and are supplied to the stepping motors 70L, 70C and 70R. Thus, the stepping motors 70L, 70C and 70R are rotated, and as the stepping motors 70L, 70C and 70R are being rotated, the reels 14L, 14C and 14R are also rotated. Each of the stepping motors 70 is the 1-2 phase excitation stepping motor, in which a step angle is 0.9°, and the number of steps per rotation is 400. Hence, when 400 pulses are supplied to each of the stepping motors 70, the reel corresponding thereto makes one rotation.

When the rotations of the reels 14L, 14C and 14R are started, the sub CPU 61 supplies low-frequency pulses to the motor drive circuit 62, and then increases the frequency of the pulses gradually. As the frequency of the pulses is being increased, rotation speed of the reels 14L, 14C and 14R is increased. After a predetermined time has elapsed, the sub CPU 61 constantly maintains the frequency of the pulses, and rotates the reels 14L, 14C and 14R at constant speed.

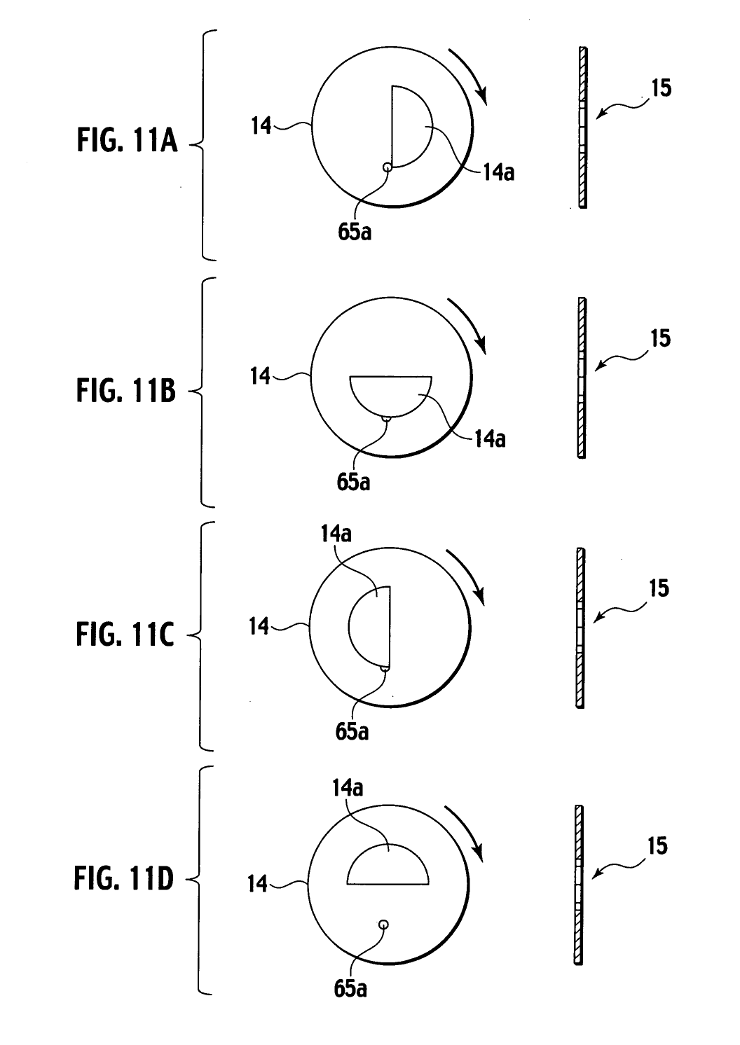

A description will be made of a rotation action of each of the reels 14 with reference to FIGS. 11A to 11D.

As shown in FIG. 11A, a semicircular metal plate 14a is provided on a surface of the reel 14. The metal plate 14a is rotated together with the reel 14. Moreover, on the circumferential surface of the reel 14, 22 symbols (refer to FIG. 3) are displayed. Three symbols among the 22 symbols displayed on the circumferential surface of the reel 14 are visually recognized by the player through the display window 15 formed in front of the reel 14. Arrows in FIGS. 11A to 11D indicate a rotation direction of the reel 14. Moreover, on one side of the reel 14, an approach sensor 65a is provided. The approach sensor 65a detects the metal plate 14a. The approach sensor 65a is not moved or rotated even if the reel 14 is rotated.

FIG. 11A shows a position (hereinafter, position A) of the metal plate 14a at a moment when the metal plate 14a starts to be detected by the approach sensor 65a. When the reel 14 is rotated when the metal plate 14a is located at the position A, the metal plate 14a is moved to a position shown in FIG. 11B. FIG. 11B shows a position (hereinafter, position B) of the metal plate 14a at a moment when the metal plate 14a is detected by the approach sensor 65a. When the reel 14 is rotated when the metal plate 14a is located at the position B, the metal plate 14a is moved to a position shown in FIG. 11C. FIG. 11C shows a position (hereinafter, position C) of the metal plate 14a at a moment when the metal plate 14a becomes not to be detected by the approach sensor 65a.

When the reel 14 is rotated when the metal plate 14i a is located at the position C, the metal plate 14a is moved to a position shown in FIG. 11D. FIG. 11D shows a position (hereinafter, position D) of the metal plate 14a when the metal plate 14a is not detected by the approach sensor 65. When the reel 14 is further rotated, the metal plate 14a returns to the position A. As the reel 14 is being rotated, the position of the metal plate 14a is changed in order of the position A, the position B, the position C, the position D, the position A . . . .

The approach sensor 65a constructs the index detection circuit 65 (refer to FIG. 4). A state where the approach sensor 65a is detecting the metal plate 14a is defined to be “High”, and a state where the approach sensor 65a is not detecting the metal plate 14a is defined to be “Low”. Then, when the metal plate 14a is located at the position A→the position B→the position C, the state of the index detection circuit 65 is “High”, and when the metal plate 14a is located at the position C→the position D the position A, the state of the index detection circuit 65 is “Low”. Moreover, the sub CPU 61 recognizes the rotation position of the reel 14 by taking a rise from “Low” to “High” as an index (origin) 1 and taking a drop from “High” to “Low” as an index (origin) 2.

After transmitting the start signal to the sub CPU 61 in Step S61 in FIG. 10, the main CPU 40 executes an effect at the time when the reels are rotated (Step S62). In this process, over a period (for example, three seconds) determined in response to a result of the lottery process (Step S14 in FIG. 6) and the like, an effect image is displayed on the lower image display panel 16, and/or a sound is outputted from the speaker 29.

Next, the main CPU 41 determines whether or not it is timing to instruct the stop of the rotations of the reels 14L, 14C and 14R (Step S63).

The timing to instruct the stop of the rotations of the reels 14L, 14C and 14R is timing from a moment when an effect of the reel rotating time is ended by the minimum necessary period of time for stopping the rotations of the reels 14L, 14C and 14R.

In Step S63, when it is not the timing to instruct the stop of the rotations of the reels 14L, 14C and 14R (NO in Step S63), the main CPU 41 remains in Step S63, and performs the effect of the reel rotating time. When it is the timing to instruct the stop of the rotations of the reels 14L, 14C and 14R (YES in Step S63), the main CPU 41 transmits, to the sub CPU 61, the code numbers of the reels 14L, 14C and 14R, which are stored in the RAM 43 (Step S64). Upon receiving the code numbers from the main CPU 41, the sub CPU 61 converts each code number into the stopped position (number of steps) of the reel from the index based on a correspondence table between the number of steps and the code numbers, which is stored in a ROM (not shown) provided in the sub CPU 61 (Step S72).

In the correspondence table in FIG. 12, each code number corresponds the symbols drawn on the outer circumferential surfaces of the respective reels (refer to FIG. 3). The symbols of the code numbers “00” to “10” correspond to the index 1. Moreover, the symbols of the code numbers “11” to “21” correspond to the index 2. The number of steps is the number of steps, which takes the index 1 as a reference. For example, if the code number is “08”, 145 steps from the index 1 is the stopped position of each reel. Moreover, if the code number is “12”, 218 steps from the index 1 is the stopped position of each reel.

Next, the sub CPU 61 performs a reel stopping process (Step S73). In this process, the sub CPU 61 detects the rise (index 1) from “Low” to “High” in the index detection circuit 65 for each reel. Upon detecting the index 1, the sub CPU 61 supplies, to the motor drive circuit 62, pulses equivalent to the number of steps, which is converted from the code number decided in Step S52 in FIG. 8, and then stops the supply of the pulses.

For example, when it is decided in Step S72 that the stopped position of each reel is 145 steps from the index 1, the sub CPU 61 supplies 145 pulses to the motor drive circuit 62 at the time when the index 1 is detected, and then stops the supply of the pulses. Moreover, when it is decided in Step S72 that the stopped position of each reel is 218 steps from the index 1, the sub CPU 61 supplies 218 pulses to the motor drive circuit 62 at the time when the index 1 is detected, and then stops the supply of the pulses. Thus, the symbol combination decided in Step S72 is arranged on the payline L in accordance with the code number decided in Step S72. Meanwhile, the main CPU 41 ends the effect of the reel rotating time (Step S65).

When the index corresponding to the code number transmitted in Step S64 and the index detected by the index detection circuit 65 when the rotation of each reel is stopped are different from each other, a synchronization loss occurs. Accordingly, the main CPU 41 displays an error message on the lower image display panel 16, and interrupts the game.

For example, in the case where the index 1 is detected by the index detection circuit 65 when the rotation of the reel 14L is stopped though a process to stop the reel 14L at the code number 12 corresponding to the index 2 is performed, the main CPU 41 interrupts the game.

As shown in FIG. 14, on a lower portion of the lower image display panel 16, an image 92 which shows an arrow indicating the above and “Look Up” is displayed. The image 92 is an image for prompting the player to see the upper image display panel 33.

In synchronization with the above-described image display, the upper image display panel 33 displays the characters that say “Bonus is established!! You can stop the reels by pushing the buttons.” By seeing this display, the player can recognize that it is possible to stop the rotating reels 14L, 14C and 14R by pushing the stop switches 82L, 82C and 82R.

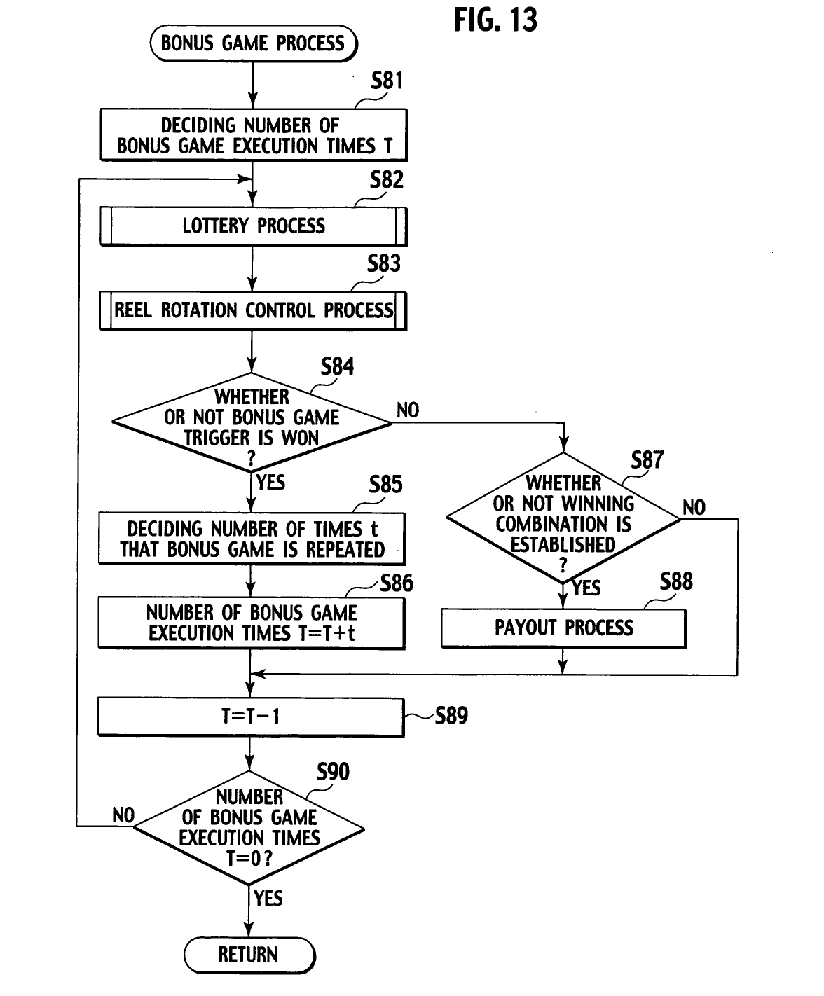

Next, a description will be made of the procedure of the bonus game process shown in Step S20 in FIG. 6 with reference to FIG. 13.

The main CPU 41 decides the number of times T that the bonus game is executed from among 10 to 25 games based on the random number value obtained by executing the random number generating program included in the lottery program stored in the RAM 43 (Step S81). The main CPU 41 stores, in the RAM 43, data regarding the decided number of times T that the bonus game is executed.

Next, the main CPU 41 performs a lottery process (Step S82), and a reel rotation control process (Step S83). The lottery process is a substantially similar process to the lottery process in FIG. 8. Moreover, the reel rotation control process is a substantially similar process to the reel rotation control process in FIG. 10. These processes have already been described, and accordingly, a description thereof will be omitted here.

Next, the main CPU 41 determines whether or not the bonus game trigger is established, that is, whether or not the three symbols of “APPLE” are arranged on the payline L formed in the display windows 15L, 15C and 15R (Step S84). When the main CPU 41 determines that the bonus game trigger is established (YES in Step S84), the main CPU 41 newly decides, by the lottery, a number of time t that the bonus game is repeated (Step S85), and adds the decided number of times t to the current number of times T that the bonus game is executed (Step S86). Thus, when another bonus game is won during the bonus game, the remaining number of times that the bonus game can be executed is increased.

When the bonus game trigger is not established (NO in Step S84), the main CPU 41 determines whether or not the winning combination is established (Step S87). When the winning combination is established (YES in Step S87), the main CPU 41 pays out the coins corresponding to the number of inserted coins and to the winning combination (Step S88).

When the process of Step S86 or S88 is executed, or when the winning combination is not established (NO is Step S87), the main CPU 61 reads out the number of times that the bonus game is executed, which is stored in the RAM 43, and subtracts 1 from the a value of the read-out number of times T. Then, the main CPU 61 stores the reduced number of times T in the RAM 43 one more time (Step S89).

Next, the main CPU 41 determines whether or not the number of times T that the bonus game is executed has reached the number of times, which is decided in Step S81 (Step S90). Specifically, the main CPU 41 determines whether or not the number of times T, which is stored in the RAM 43, has become 0, and when the number of times T is not 0, that is, when the number of times that the bonus game is executed has not reached the number of times, which is decided in Step S81, returns to Step S82, and repeats the above-described processes.

Meanwhile, when the number of times T is 0, that is, in the case of determining that the number of times that the bonus game is executed has reached the number of times T, which is decided in Step S81, the main CPU 41 ends the process.

Next, a description will be made of advantageous features of the slot machine and the playing method thereof according to this embodiment.

When the bonus game is won, the play plays the stop switches 82L, 82C and 82R, and the stop control game capable of stopping the rotating reels 14L, 14C and 14R is thus started. Then, in the case where the player pushes the stop switches 82L, 82C and 82R to stop the reels 14L, 14C and 14R, when the symbol of “APPLE” as the symbol for establishing the bonus game trigger is stopped on the payline L, the bonus game is executed.

Specifically, in the slot machine and the playing method thereof according to this embodiment, when the bonus game is won to bring the state where it is possible to shift to the bonus game, that is, when the combination of the symbol rearranged on the payline L is decided to be “APPLE” as the specific combination, the main CPU 41 receives the external control input signal generated by pushing the stop switches 82L, 82C and 82R, and executes the stop control game capable of rearranging the symbols.

Hence, there can be provided a new entertainment factor that the rotating reels 14L, 14C and 14R are stopped in such a manner that the player pushes the stop switches 82L, 82C and 82R by him/herself, thus making it possible to establish the bonus game trigger. Therefore, the player can be prevented from losing interest in the game.

Moreover, the number of credits is not consumed when the stop control game is executed. Specifically, in the case where the stop control game is started, and the player stops the reels 14L, 14C and 14R by pushing the stop switches 82L, 82C and 82R, when the symbol of “APPLE” is not stopped on the payline L formed in the display windows 15L, 15C and 15R, the main CPU 41 rotates the reels 14L, 14C and 14R one more time and executes the stop control game one more time without receiving the input signal from the coin counter 21C or the spin switch 23S. When the symbol combination of “APPLE” is stopped on the payline L in the executed stop control game, the main CPU 41 ends the stop control game, inactivates the operations for the stop switches 82L, 82C and 82R, and prohibits the reception of the external control input signal.

Hence, even if the player cannot stop the symbol combination of “APPLE” on the payline L by pushing the stop switches 82L, 82C and 82R in one stop control game, the stop control game which does not consume the coins is executed plural times. Accordingly, the symbol combination of “APPLE” is stopped on the payline L by repeating the stop control game some times, thus making it possible to shift the gaming mode to the bonus game.

Moreover, in the case where the symbol combination of “APPLE” is not stopped on the payline L even if the stop control game is executed the predetermined number of times (for example, ten times) set as the limited period, the main CPU 41 inactivates the operations for the stop switches 82, stops the symbol combination of “APPLE” on the payline L, and shifts the gaming mode to the bonus game. Hence, even if the player cannot stop the symbol combination of “APPLE” on the payline L, the player can surely stop the symbol combination of “APPLE” on the payline L after the stop control game is executed the predetermined number of times (for example, ten times), and can shift the gaming mode to the bonus game.

Specifically, a player who has a so high technical level that can stop the symbol combination of “APPLE” on the payline L can stop the symbol combination of “APPLE” on the payline L at an early moment while the stop control game is being repeated plural times, and can shift the gaming mode to the bonus game. Meanwhile, even if a player is not good at stopping the symbol combination of “APPLE” on the payline L, the player is given an opportunity to stop the symbol combination of “APPLE” on the payline L in such a manner that the stop control game which does not consume the coins is repeated plural times. Moreover, even if the player cannot stop the symbol combination of “APPLE” on the payline L even in the case where the stop control game is executed the predetermined number of times, the symbol combination of “APPLE” is stopped on the payline L by the control of the main CPU 41, thus making it possible for the player to shift the gaming mode to the bonus game.

Hence, when the state where it is possible to shift to the bonus game is brought, the player can surely stop the symbol combination of “APPLE” on the payline L and establish the bonus game trigger without consuming the coins no matter whether the technical level of the player may be high or low. Moreover, the player who has the high technical level can shift the gaming mode to the bonus game at an early moment. Accordingly, the game of the slot machine can allow the technique of the player to be involved therein.

Note that, in the bonus game, the establishment probability of the bonus trigger, the establishment probabilities of the various winning combinations, and/or the numbers of payouts for the various winning combinations may be varied in response to the number of times that the stop symbol game is executed when the symbol combination of “APPLE” is stopped on the payline L. For example, in the case where the symbol combination of “APPLE” is stopped on the payline L while the stop symbol game is being executed a small number of times, the establishment probability of the bonus trigger and the establishment probabilities of the various winning combinations are increased in the bonus game. Thus, the player can be prevented more from losing interest in the game.

The description has been made above of the embodiment of the slot machine according to the present invention. However, the embodiment only illustrates a specific example, and does not limit the present invention in particular. It is possible to appropriately change designs of specific configurations of the respective means and the like. Moreover, the effects described in the embodiment of the present invention only list the most suitable effects generated from the present invention, and the effects from the present invention are not limited to those described in the embodiment of the present invention.

What is claimed is:

1. A slot machine comprising:
a display; and
a controller operable to shift a game mode to a stop control game based on an external control input signal only when a combination of a plurality of symbols arranged on the display coincides with a specific combination, in a case of rearranging the plurality of symbols on the display, the stop control game making it possible to rearrange the plurality of symbols.

2. The slot machine according to claim 1, wherein, when the combination of the symbols is rearranged to the specific combination in the stop control game, the controller does not receive the control input signal.

3. The slot machine according to claim 1, wherein the controller repeats a unit game in which the plurality of symbols are automatically rearranged, and in the unit game after the game mode is shifted to the stop control game, makes it possible to rearrange the combination of the symbols to the specific combination based on the control input signal.

4. The slot machine according to claim 1, wherein the stop control game is ended after an elapse of a predetermined period.

5. A slot machine comprising:
a display; and
a controller operable to rearrange a plurality of symbols arranged on the display, and decide a combination of the symbols to be rearranged,
wherein, when the combination of the symbols coincides with a specific combination, the controller shifts a game mode from a base game in which the plurality of symbols are automatically rearranged to a stop control game, the stop control game making it possible to rearrange the plurality of symbols for a predetermined period based on an external control input signal.

6. The slot machine according to claim 5, wherein, when the combination of the symbols is rearranged to the specific combination in the stop control game, the controller does not receive the control input signal.

7. The slot machine according to claim 5, wherein the controller repeats a unit game in which the plurality of symbols are automatically rearranged, and in the unit game after the game mode is shifted to the stop control game, makes it possible to rearrange the combination of the symbols to the specific combination based on the control input signal.

8. A slot machine comprising:
a display operable to include a symbol matrix formed by a plurality of columns and a plurality of rows, and a payline set on the symbol matrix;
an arrangement controller operable to decide symbols to be arranged on the symbol matrix after scrolling a plurality of the symbols on the display, and stop scrolling the plurality of symbols to arrange the decided symbols on the symbol matrix;
a stop switch associated with the arrangement controller and operatable by a player; and
a stop switch controller operable to activate an operation for the stop switch only when a combination of the symbols arranged on the payline coincides with a specific combination, and rearrange the symbols on the symbol matrix in response to operation input timing for the stop switch by the player.

9. The slot machine according to claim 8, wherein the stop switch controller inactivates the operation for the stop switch when the combination of the symbols rearranged on the payline coincides with the specific combination after activating the operation for the stop switch.

10. The slot machine according to claim 8, wherein the rearrangement controller repeats a unit game in which automatically decides the symbols to be rearranged on the symbol matrix after scrolling the plurality of symbols on the display and the decided symbols are rearranged on the symbol matrix, and in the unit game when the operation for the stop switch is activated, the stop switch controller makes it possible to rearrange the specific combination on the payline in response to the operation input timing for the stop switch.

11. The slot machine according to claim 8, wherein the stop switch controller inactivates the operation for the stop switch after an elapse of a predetermined time after activating the operation for the stop switch.

12. A playing method of a slot machine comprising:
repeating a unit game in which a plurality of symbols are automatically rearranged so that a combination of the symbols can be arranged on a display, the combination being decided by a controller; and
making it possible to rearrange the plurality of symbols based on an external arrangement signal only when the combination of the symbols coincides with a specific combination.

13. The playing method of a slot machine according to claim 12, wherein the step of making it possible to rearrange the plurality of symbols based on the arrangement signal is ended after an elapse of a predetermined period.

14. A playing method executed in a slot machine comprising:
deciding a plurality of symbols by a controller, the symbols to be rearranged on a display, in a case of rearranging the plurality of symbols arranged on the display;
rearranging, on the display, the plurality of symbols decided by the controller; and
activating an operation for a stop switch associated with the controller only when a combination of the symbols rearranged on the display coincides with a specific combination, and executing the rearrangement of the plurality of symbols in response to the operation for the stop switch.

15. The playing method executed in a slot machine according to claim 14, further comprising:
inactivating the operation for the stop switch after an elapse of a predetermined time after activating the operation for the stop switch, and rearranging, on the display, the plurality of symbols decided by the controller.

16. A playing method executed in a slot machine comprising:
repeating a unit game in which a game is started by scrolling a plurality of symbols on a display based on a control of a controller, and the game is ended by arranging the plurality of symbols on the display based on a control of the controller;
executing, as a first control state, rearrangement of the plurality of symbols based on an arrangement signal from a stop switch connected to the controller when a combination of the symbols arranged on the display coincides with a specific combination;
determining whether or not the combination of the rearranged symbols coincides with the specific combination in the first control state; and
automatically rearranging the plurality of symbols as a second control state to realize a combination of symbols decided by the controller when the combination of the rearranged symbols coincides with the specific combination.
